(19) United States
(12) Patent Application Publication
(10) Pub. No.: US 2025/0030321 A1
(43) Pub. Date: Jan. 23, 2025

(54) AN ELECTRIC OR HYBRID ELECTRIC-ENDOTHERMIC TRACTION SYSTEM AND A RECONFIGURATION METHOD FOR AN ELECTRIC MACHINE

(71) Applicant: ELDOR CORPORATION S.P.A., Orsenigo (Como) (IT)

(72) Inventors: Javier Eduardo PEREIRA RIVAS, Orsenigo (Como) (IT); Luca ZAI, Orsenigo (Como) (IT); Pasquale FORTE, Orsenigo (Como) (IT); Michele ROMAN, Orsenigo (Como) (IT)

(21) Appl. No.: 18/709,477

(22) PCT Filed: Nov. 10, 2022
(86) PCT No.: PCT/IB2022/060823

§ 371 Date: May 10, 2024

(30) Foreign Application Priority Data
Nov. 12, 2021 (IT) 102021000028769

(51) Int. Cl. H02K 11/33; H02K 7/00

(52) U.S. Cl. CPC H02K 11/33; H02K 7/006; H02K 2213/06

(57) ABSTRACT

An electric or hybrid electric-endothermic traction system comprises an electric machine, an inverter, a battery, and a switching device configured to switch between a low-speed configuration, in which the stator windings assume a first electric configuration, and a high-speed configuration, in which the stator windings assume a second electric configuration, wherein the first electric configuration results in a voltage induced by the rotation of the rotor that, on reaching a pre-determined threshold value of the angular velocity of the rotor, exceeds a supply voltage of the battery, whereas the second electric configuration of the stator windings results in a voltage induced by the rotation of the rotor that is lower than the voltage of the battery for any angular velocity within a range of use of the machine. An emergency device is connected to the switching device, control unit and/or inverter.

The present invention relates to an electric or hybrid electric-endothermic traction system and a method for reconfiguring an electric machine.

The present invention therefore finds its main, but not exclusive, application in the field of traction systems for electric or hybrid vehicles, in particular in the control of electric machines with variable configuration.

In fact, in the automotive sector there is an ever-increasing need to design and provide low-emission traction systems that, at the same time, guarantee high performance over a wide operating range, providing the user with a driving comfort and safety level comparable to those of traditional endothermic engines.

The issue of safety, although less felt in the media, is one of the main obstacles to the spread of electric vehicles to date, as achieving safety conditions similar to those of traditional vehicles requires complex and expensive control systems.

One of the most long-standing problems in terms of safety is linked to the possibility that, due to a system error or control problems, the drive inverter of the electric machine will be disconnected when the machine is in a work area where it operates as an uncontrolled generator (Uncontrolled Generator Operations—UGO).

This condition results in a sudden, uncontrolled braking action by the electric machine, which is hardly desired in any application but which, in the automotive sector, becomes totally unacceptable and extremely dangerous.

For example, this condition may occur when, in the absence of drive from the inverter, the voltages induced by the rotation of the rotor of the electric machine (back electromotive force—BEMF) tend to exceed the voltage level of the battery pack, thus reverting the energy flow from the machine to the battery and exerting a sudden braking effect on the rotor.

This problem is also felt in the design of new generation electric machines, the so-called “variable configuration” electric machines, in which the stator windings are segmented to be connected to each other in a variable way, thus allowing a single electric machine to efficiently cover the application range of several engines.

In fact, in some cases, changing the configuration requires disconnecting the inverter for a few fractions of a second, making it essential that this operation take place in safe conditions.

In order to mitigate the risks associated with switching off the inverter under hazardous conditions, the prior art adopts an active safety strategy at both software and hardware level, involving the closure of the high (or low) legs of the inverter, thus blocking the propagation of the energy flow to the battery pack and making the amount of braking negligible. In the automotive field, this strategy is known as an active short circuit.

However, this strategy, which per se is certainly efficient and effective, leads to a significant increase in product complexity and costs.

The short circuit, intentionally generated to isolate the battery pack, generates high energy which recirculates between two power components: the inverter and the electric machine. As a result, these two components must be oversized to be able to withstand the amount of circulating energy. In addition, since the short circuit must be actively generated by the inverter, all components belonging to this subsystem must be in working order at all times, even in the event of a fault. This means that the power supply, sensors, control logics, and inverter actuation must be designed to withstand all conditions. This in turn involves choosing robust components or creating redundant branches, which make the product more expensive and complicated.

Therefore, it is an object of the present invention to provide an electric or hybrid electric-endothermic traction system and a method for reconfiguring an electric machine, which can overcome the above-mentioned drawbacks of the prior art.

In particular, it is an object of the present invention to provide an electric or hybrid electric-endothermic traction system with a simplified architecture and reduced product costs.

A further object of the present invention is to provide an electric or hybrid electric-endothermic traction system and a method for reconfiguring an electric machine, which are particularly efficient and reliable.

Said objects are achieved by means of an electric or hybrid electric-endothermic traction system and a method for reconfiguring an electric machine, which have the features of one or more of the subsequent claims.

In particular, the traction system provides for the presence of an electric machine, a switching device, an inverter, and a battery pack.

The electric machine comprises a stator equipped with multiple stator windings (either wire or hairpin stator windings) and a rotor housed in the stator and configured to rotate with an angular velocity that varies depending on the machine's operating conditions.

The switching device is associated with the stator of said electric machine and is configured to switch the stator between a low-speed configuration, wherein the stator windings assume a first electric configuration, and a high-speed configuration, wherein the stator windings assume a second electric configuration.

Therefore, the stator windings have a variable configuration and can be selectively connected in at least two distinct ways in order to assume the first or the second electric configuration.

The inverter is associated with the electric machine to drive it, whereas the battery pack is connected to the electric machine to power it.

According to one aspect of the invention, the first electric configuration of the stator windings determines a voltage induced by the rotation of the rotor that, on reaching a predetermined threshold value of the angular velocity of the rotor, exceeds a supply voltage of the battery pack.

Therefore, in the low-speed configuration, as the angular velocity of the rotor increases, the induced voltage (BEMF) increases until it exceeds the supply voltage of the battery pack.

In contrast, the second electric configuration of the stator windings determines a voltage induced by the rotation of the rotor that is lower than said voltage of the battery pack for any angular velocity within a range of use of the electric machine.

In other words, according to one aspect of the invention, the second configuration is such that, regardless of the angular velocity of the rotor, the electric machine never works in an operating area where it can operate as an uncontrolled generator (UGO).

Furthermore, according to a first aspect of the invention, the switching device is configured to switch the stator windings from the low-speed configuration to the high-speed configuration when said rotor reaches a switching speed less than or equal to said threshold value.

Preferably, therefore, the switching device determines a value of the switching speed (floating or fixed) giving it a value that is always lower than the threshold value, so that for any angular velocity higher than said threshold value the electric machine is in the high-speed configuration, i.e., a configuration in which the induced voltages do not exceed the supply voltage of the battery.

This advantageously eliminates the need for an “active” safety strategy, the system being inherently safe and reliable.

In order to maximize this reliability, also overcoming any faults in the control strategy, the system comprises a control unit configured to compare a value of the angular velocity of the rotor at a predetermined time point with said threshold value and disable the switching device if said angular velocity value is greater than said threshold value.

Advantageously, in this way, not only does the control unit, through the switching device, carry out the switching before the threshold value is exceeded, but once said value is exceeded, it also disables the switching device itself so as to prevent any faults in the control loop from resulting in a return to the first configuration at too high speeds.

Preferably, in addition, it should be noted that the switching device comprises at least one movable body that can move between a first position, in which it arranges the stator windings in the first electric configuration, and a second position, in which it arranges the stator windings in the second electric configuration, and an actuator associated with said movable body to move it between the first and the second position.

Preferably, the control unit is configured to disable said actuator when said angular velocity value, measured at said predetermined time point, is greater than said threshold value.

Advantageously, therefore, it is the actuator of the switching device that is disabled in the working area where, in the low-speed configuration, there would be a risk of operating in the uncontrolled generator condition.

More preferably, the control unit is configured to send two different “parallel” signals to said switching device.

A driving signal, selectively switchable between a first value, representing the low-speed condition, and a second value, representing the high-speed condition.

An enabling signal selectively switchable between a first value, in which the switching device is enabled for switching, and a second value, in which the switching device is disabled.

It should be noted that the switching device is configured for switching only after the control unit receives an enabling signal having the first value, thereby making the system more robust against any faults.

In order to maximize its reliability, the control unit should preferably be composed of at least a first subunit, and a second subunit operatively arranged in parallel and redundant with respect to said first subunit.

The first subunit is configured to generate said driving signal.

The second subunit is configured to generate said enabling signal.

Advantageously, this architecture also prevents the possible onset of errors due to damage or faults of the individual subunit, ensuring that at least the other subunit continues to operate smoothly, and minimizing, if not zeroing, any reconfiguration in a dangerous speed range.

According to a further, complementary or alternative aspect of the invention, the system comprises an emergency device connected to said switching device, to said control unit, and/or to said inverter.

The emergency device is configured to:
receive a first signal representing an operating condition of said control unit and/or of said inverter from said control unit and/or from said inverter; said first signal being able to assume at least one first value, representing the full operation of the control unit and/or of the inverter, and at least one second value, representing a partially or totally inoperative condition of said control unit and/or of said inverter;
send a second signal to said switching device when said first signal has said second value.

Preferably, the second signal alternately represents:
a switching of the stator from the low-speed configuration to the high-speed configuration, if said stator is in the low-speed configuration;
a disabling of the switching device, if said stator is in the high-speed configuration.

Advantageously, in this way it is possible to maximize the safety of the system under all conditions of use, even if the electric machine is switched off (i.e., inverter deactivated/inoperative) and driven into a dangerous working area by foreign factors (e.g., primary drive unit or descent).

Further features and advantages of the present invention will become more apparent from the indicative, and therefore non-limiting description of a preferred, but not exclusive, embodiment of an electric or hybrid electric-endothermic traction system and a method for reconfiguring an electric machine, as illustrated in the accompanying drawings wherein:

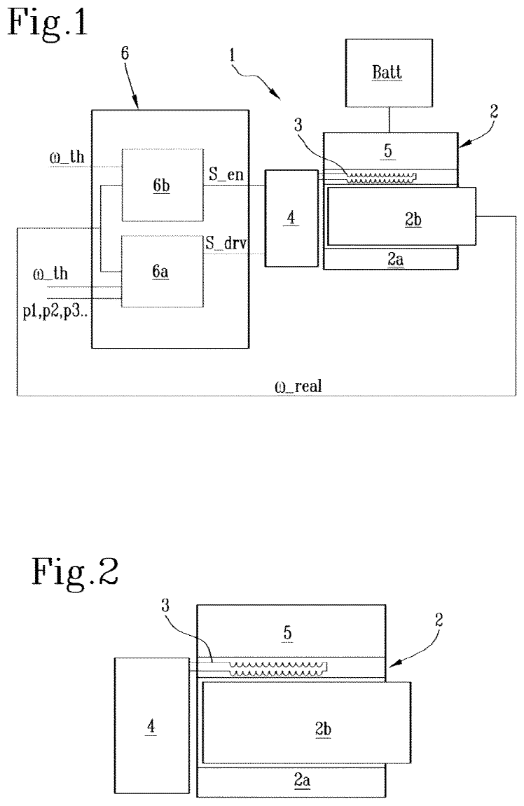

FIG. 1 shows a representative diagram of an electric or hybrid electric-endothermic traction system according to the present invention, with the electric machine in a first operating configuration;

FIG. 2 schematically shows the electric machine in FIG. 1, in a second operating configuration;

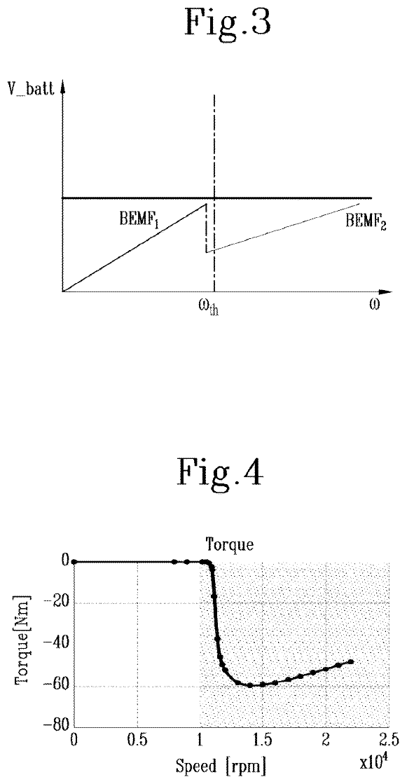

FIG. 3 shows a representative diagram of a method for reconfiguring an electric machine according to the present invention;

FIG. 4 shows a representative diagram of the behaviour of the electric machine, in a torque-speed plane, in the absence of an appropriate control logic;

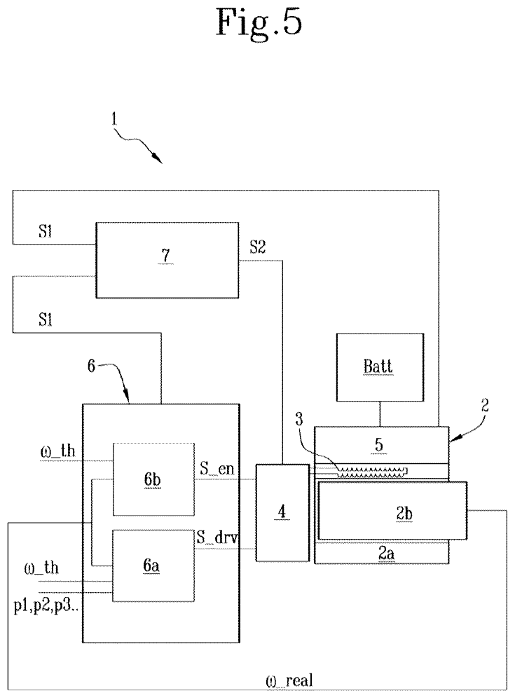

FIG. 5 shows a representative diagram of an electric or hybrid electric-endothermic traction system according to a further embodiment of the present invention.

With reference to the accompanying figures, the numeral 1 indicates an electric or hybrid electric-endothermic traction system for a vehicle.

The term electric or hybrid electric-endothermic as used herein is intended to mean that the traction system in accordance with the invention is of a type that can be used in any vehicle, either on or off the ground, which uses at least one electric traction unit, whether primary or secondary.

This traction system 1 therefore comprises at least an electric machine 2, an inverter 5, and a battery pack Batt.

This battery pack Batt is connected to the electric machine 2 through the inverter 5 to power it, with the inverter 5 designed to drive it depending on the boundary conditions (machine's operating conditions, driving by the driver, environmental conditions, etc. . . . ).

The battery pack Batt has its own voltage level V_batt, which is preferably around a nominal voltage and varies depending on the charging state of the battery pack.

The electric machine 2 comprises a stator 2a equipped with multiple stator windings 3, and a rotor 2b housed in the stator 2a.

The rotor 2b is configured to rotate with an angular velocity ω_real that varies depending on the machine's operating conditions (e.g., the commands given by the inverter 5).

The electric machine 2 can be of various kinds, but is preferably a permanent-magnet synchronous machine.

In the preferred embodiment, the stator 2a of the electric machine 2a is of the multi-phase, preferably three-phase (or six-phase) type.

In other words, in the preferred embodiment, the electric machine 2a comprises at least three stator windings 3.

The stator windings 3 are housed within a stator casing or shell, which is known per se and therefore not described in detail.

These windings can be either of the wire type, thus defined by suitably wound copper (or other conductor) coils, or of the hairpin type, thus defined by packs of suitably twisted and connected bar conductors.

Preferably, furthermore, the electric machine 2 is of the variable configuration type, i.e., it has stator windings that can be connected to each other in a variable way in order to change the electric configuration thereof, and therefore the performance of the machine.

In accordance with this, the system 1 preferably comprises a switching device 4 associated with the stator 2a of said electric machine 2.

In particular, the switching device 4 is associated with the stator windings 3 and configured to switch said stator 2a between a low-speed configuration, wherein the stator windings 3 assume a first electric configuration, and a high-speed configuration, wherein the stator windings 3 assume a second electric configuration.

In a first embodiment, for example, the electric machine 2 has multiple stator windings 3, each defining a phase; these windings are in turn divided into two or more phase fractions which can be electrically connected to each other in series or in parallel.

Alternatively, or additionally, it is the type of connection between the various phases that can be modified, for example, by changing between a star configuration and a delta configuration, or a combination of the above.

As such, these configurations are known, therefore they will not be described further herein.

It should be noted that the switching device 4 can be of a variety of types, both electromechanical and semiconductor.

The electromechanical switching device 4, described by way of example in patent documents WO2020/194230 and WO2021/079257 by the Applicant, usually comprises a fixed part, which can be constrained to the stator 2a and connected to the terminals of the stator windings 3 and/or of the fractions of each winding, and a movable part.

The movable part, by means of a suitable actuator, can be moved between a first operating position, in which it arranges the stator windings 3 in the first electric configuration, and a second operating position, in which it arranges the stator windings 3 in the second electric configuration.

Alternatively, the switching device can be defined by a semiconductor device, such as for example the one described in patent publication WO 2021/099894 owned by the Applicant, wherein the electrodes of the device are excited in a variable way in order to generate different conductive channels on the substrate, alternately defining the first or the second (or an additional) electric configuration.

It should be noted that the rotation of the rotor 2b inside the stator 2a generates, in the stator windings 3, an induced voltage (back electromotive force) that increases with the angular velocity of the rotor 2b.

According to one aspect of the invention, the first electric configuration of the stator windings 3 is such as to determine a (first) induced voltage BEMF1 that, on reaching a predetermined threshold value ω_th of the angular velocity of the rotor 2b, exceeds a supply voltage of the battery pack V_batt.

In other words, with the stator windings 3 arranged in the first configuration, as the angular velocity of the rotor increases, the induced voltage increases very strongly until it intersects and exceeds the level of the battery voltage (assumed to be constant).

In contrast, the second electric configuration of the stator windings 3 is such as to determine a (second) voltage induced by the rotation of the rotor BEMF2, which remains lower than said voltage of the battery pack V_batt for any angular velocity within a range of use of the electric machine 2.

In other words, with the stator windings 3 arranged in the second configuration, as the angular velocity of the rotor 2b increases, the induced voltage increases less strongly than in the first electric configuration, remaining below the voltage of the battery pack V_batt for any angular velocity within a range of use of the electric machine 2 (or at least for any speed that the vehicle can reach).

In this respect, it should be noted that in the second configuration the induced voltage may also exceed the voltage level of the battery pack V_batt for high-speed values exceeding the vehicle's limit performance and/or in any case difficult to reach.

Advantageously, this configuration allows the electric machine 2 to have at least one safety condition, in which even any faults or shutdowns of the inverter do not lead to the start of an uncontrolled generator operation.

Preferably, the stator windings 3 comprise multiple phases divided into phase fractions, which can be electrically connected together in series or in parallel by means of the switching device 4.

In the preferred embodiment, the first electric configuration corresponds to phase fractions connected in series, whereas the second electric configuration corresponds to phase fractions connected in parallel.

In this respect, the switching device 4 is preferably configured to switch the stator 2a from the low-speed configuration to the high-speed configuration when said rotor 2b reaches a switching speed less than or equal to said threshold value ω_th.

It should be noted that the threshold value ω_th may be the intersection value between the curve of the first induced voltage BEMF1 and the battery voltage V_batt or, preferably, a value lower than this intersection value by a preset safety coefficient.

In other words, the switching device 4 is configured to vary the stator windings from the first electric configuration to the second electric configuration when the rotor 2b reaches a switching speed less than (or equal to) the threshold speed, preferably less than the threshold speed, so as to have a greater margin of safety.

In the preferred embodiment, the switching speed is set so that it is lower than said threshold value ω_th by a predetermined margin of safety.

It should be noted that, preferably, the traction system comprises a control unit 6 associated with the switching device 4 and the inverter 5 and configured to communicate with these components.

The control unit 6 is therefore preferably configured to send to said switching device 4 a driving signal S_drv selectively switchable between a first value, representing the low-speed condition, and a second value, representing the high-speed condition.

In addition, the control unit 6 is preferably configured to compare an angular velocity value ω_real of the rotor, measured or calculated at a predetermined time point, with the threshold value ω_th.

In the preferred embodiment, the control unit 6 operates cyclically and at each cycle n compares the angular velocity ω_real measured at the previous cycle (n−1) with the threshold value ω_th (possibly also calculated at the previous cycle, if floating).

In the case of a floating threshold value, the control unit 6 is also configured to determine said threshold value ω_th prior to said comparison step (i.e., at the previous cycle n−1) and depending on the operating conditions of the electric machine 2 and/or on the state of charge of the battery pack Batt.

Upon the result of the comparison, the control unit 6 is configured to communicate with the switching device 4.

Preferably, the control unit 6 is configured to disable the switching device 4 if said angular velocity value ω_real is greater than said threshold value ω_th (or than the switching speed).

Advantageously, these measures completely overcome the need to introduce active safety systems that “short-circuit” the inverter, ensuring safety only based on the normal control logic of the electric machine.

Preferably, in addition, the control unit 6 is configured to send the switching device 4 an enabling signal S_en, which can assume a first, enabling value and a second, disabling value.

In other words, the first value of the enabling signal corresponds to a switching device 4 enabled for switching, and the second value corresponds to a switching device 4 disabled for switching.

The control unit 6 is therefore configured to send an enabling signal having the second value when the outcome of the comparison determines that the angular velocity ω_real is greater than the threshold value ω_th (or than the switching speed).

This control unit 6 is also configured to send an enabling signal having the first value when the outcome of the comparison determines that the angular velocity ω_real is less than the threshold value ω_th (or than the switching speed).

Preferably, the switching device 4 is configured for switching only after the control unit 6 receives an enabling signal having the first value.

The switching device 4 therefore has a dual input (S_en and S_drv) and is programmed/configured for switching only when it receives:
an enabling signal S_en having the first value;
a driving signal S_drv having a first or second value representing an electric configuration of the stator windings 3 which is different from the current one (i.e., at the previous cycle n−1).

In this respect, the control unit 6 preferably comprises a first subunit 6a configured to generate said driving signal S_drv, and
a second subunit 6b, operatively arranged in parallel and redundant with respect to said first subunit 6a, configured to generate said enabling signal S_en.

These subunits are preferably separate devices placed on separate supports in order to maximize the robustness of the system against failures, preventing failures or operating errors in one of the control (driving) loops from leading to malfunction of the other (enabling) loop.

In embodiments wherein the switching device 4 is of the electromechanical type (movable body and actuator), the control unit 6 is configured to disable the actuator when said current velocity value ω_real is greater than said threshold value ω_th.

In other words, in these embodiments, the enabling signal S_en is sent to the actuator and, in particular, to the power source that powers it.

If the actuator is powered by the battery pack, for example, the control unit 6 is configured to isolate the actuator from the battery pack (e.g., by means of a switch) if the current velocity value ω_real is greater than the threshold value ω_th.

In some embodiments, though, the switching device 4 comprises retaining means associated with the movable body and configured to counter a free movement of the movable body moving away from the first position and away from the second position, when the switching device is in the low-speed configuration or high-speed configuration, respectively.

In other words, the movable body of the actuator has a stable equilibrium condition in each of the positions actively imposed by the actuator, so that any vibrations or shocks are prevented from inadvertently switching the configuration of the stator windings 3.

In the preferred embodiment, the retaining means may be of the elastic type or be defined by an appropriate shape of the guide systems which allow the movable body to move between the two positions.

Furthermore, according to another, complementary or alternative aspect of the invention, the traction system 1 comprises an emergency device 7 connected to said switching device 4, control unit 6, and inverter 5.

This emergency device 7 is complementary to the control unit 6 and defines a component different from the control unit 6 and the inverter 5, and is additional thereto and arranged on a redundant control loop, which helps to maximize the safety and the robustness against failures of the system 1.

In fact, this emergency device 7 is configured to receive a first signal S1 representing an operating condition of said control unit 6 and/or of said inverter 5 from the control unit 6 and/or from said inverter 5.

Preferably, the emergency device 7 is configured to receive a first signal from both the control unit 6 and the inverter 5 in order to maximize the efficiency of the system.

Alternatively, the signal could be one and having information representing the state of both components.

The first signal S1 can preferably have at least a first value and a second value.

The first value represents the full operation of the control unit 6 and/or of the inverter 5.

The second value represents a partially or totally inoperative condition of said control unit 6 and/or of said inverter 5.

Thanks to the first signal S1, therefore, the emergency device 7 receives information representing any damage to or failure of the control line of the electric machine 2.

The emergency device 7 is also configured to send a second signal S2 to the switching device 4 when said first signal S1 has said second value.

The second signal may represent a switching of the stator 2a from the low-speed configuration to the high-speed configuration, if said stator is in the low-speed configuration.

Alternatively, or additionally, the second signal may represent a disabling of the switching device 4, if said stator is in the high-speed configuration.

This second signal S2 can therefore be defined either by two different signals, each one having information content, or by a single signal containing both contributions.

Advantageously, in this way, in the event of failure or malfunction, or simply when the inverter 5 is deliberately switched off by the vehicle control unit, the emergency device 7 is capable of reconfiguring the electric machine or keeping it in a safe condition, which corresponds to the high-speed configuration (in which the induced voltages do not exceed the battery voltage V_batt).

The emergency device, therefore, is capable of “forcing” the reconfiguration or actively disabling it, even if the control unit 6 does not foresee this condition.

Consider, for example, the use of an electric drive unit in support of a primary unit, which, if inactive (e.g., switched off) could be driven at speeds above the threshold value ω_th, entailing all the risks described above.

Thanks to the emergency device, the system 1 manages to overcome this drawback, reaching a higher level of safety even if the control loop of the switching device does not envisage reconfiguration below the threshold speed ω_th (e.g., because it is switched off).

In an alternative embodiment, the second signal S2 can be continuously sent from the emergency device 7 to the switching device 4; in this case, the second signal S2 may assume at least two different values, one which does not impart any action and one which actively acts on the switching device 4 (reconfiguring and/or disabling it).

In the preferred embodiment, the emergency device 7 is defined by an SBC device configured to receive the incoming first signal S1 (or first signals S1) and to return the outgoing second signal S2 (or second signals S2) along a control branch parallel to that of the control unit 6.

A further object of the present invention is a method for reconfiguring an electric machine 2 with variable configuration and powered by a battery pack Batt, which is preferably, but not exclusively, implemented by the system described above.

The method will therefore be described in greater detail below, stressing straight away that all the features mentioned and described in relation to the system 1, where not expressly indicated or in case of incompatibility, are to be considered applicable mutatis mutandis to the following description of the method object of the present invention.

In accordance with the invention, the method comprises determining the angular velocity of the rotor ω_real and switching stator windings 3 from the first configuration to the second configuration when said rotor 2b reaches a switching speed below said threshold value ω_th.

As already clarified in the description of the system, this in fact guarantees the operation of the electric machine 2 within a safe working range, which does not lead to an uncontrolled generator condition.

Preferably, the method preliminarily comprises comparing an angular velocity value ω_real of the rotor at a predetermined (previous) time point with the threshold value ω_th (optionally pre-calculated, as described above) and disabling any switching from the second configuration to the first if said angular velocity value ω_real is greater than said threshold value ω_th.

The invention achieves the intended objects and attains important advantages.

In fact, the presence of a traction system that allows the machine to work in safe working areas at all times, while maintaining a high and wide operating range, allows the drawbacks of the prior art to be overcome.

The use of stator windings allowing a high-speed configuration that does not lead to uncontrolled generator conditions and of a control which imparts switching at suitable speeds allows risks to be avoided in normal machine operation.

Furthermore, the provision of a parallel disabling channel, which is redundant and additional to the driving line/loop of the switching device, greatly increases the level of safety and reliability of the system, making it robust against various types of errors.

In particular, these measures completely overcome the need to introduce active safety systems that “short-circuit” the inverter, ensuring safety only based on the normal control logic of the electric machine.

Therefore, these measures result in the system being reliable and at the same time simple and inexpensive for the manufacturer.

In addition, if present, the use of an emergency device allows the reliability of the system to be maximized, preventing the establishment of a braking torque even under conditions in which the control loop of the switching system might not operate.

1. An electric or hybrid electric-endothermic traction system, comprising:
an electric machine comprising a stator equipped with multiple stator windings and a rotor housed in the stator and configured to rotate with an angular velocity (ω_real) that varies depending on the machine's operating conditions;
a switching device associated to the stator of said electric machine and configured to switch said stator between a low-speed configuration, wherein the stator windings take a first electric configuration, and a high-speed configuration, wherein the stator windings take a second electric configuration;
an inverter associated to said electric machine in order to drive it;
a battery pack (Batt) connected to said electric machine to supply power to the electric machine;
a control unit configured to drive said switching device and/or said inverter depending on the operating conditions of the electric machine;
wherein:
said first electric configuration of the stator windings determines a voltage induced by the rotation of the rotor (BEMF1) that, on reaching a pre-determined threshold value (ω_th) of the angular velocity of the rotor, exceeds a supply voltage of the battery pack (V_batt);
said second electric configuration of the stator windings determines a voltage induced by the rotation of the rotor (BEMF2) that is lower than said voltage of the battery pack (V_batt) for any angular velocity within a range of use of the electric machine;
characterised in that it comprises an emergency device connected to said switching device, to said control unit, and/or to said inverter and configured to:
receive a first signal representing an operating condition of said control unit and/or of said inverter from said control unit and/or from said inverter; said first signal being able to assume at least one first value, representing the full operation of the control unit and/or of the inverter, and at least one second value, representing a partially or totally inoperative condition of said control unit and/or of said inverter;
send a second signal to said switching device when said first signal has said second value, wherein said second signal is alternately representing:
a switching of the stator from the low-speed configuration to the high-speed configuration, if said stator is in the low-speed configuration;
a disabling of the switching device, if said stator is in the high-speed configuration.

2. The traction system according to claim 1, wherein the emergency device is configured, alternatively, to:
receive a first signal both from the control unit and from the inverter;
receive a single first signal having information representing the operating state of both the control unit and the inverter.

3. The traction system according to claim 1, wherein the emergency device is defined by an SBC device configured to receive the incoming first signal and to return the outgoing second signal along a control branch parallel to a control branch that goes from the control unit to the switching device.
